(19) United States
(12) Patent Application Publication
(10) Pub. No.: US 2017/0234446 A1
(43) Pub. Date: Aug. 17, 2017

(54) VALVE CLOSURES

(71) Applicant: IS/\MI Vision Inc., Caledon (CA)

(72) Inventors: Michael Maloney, Bolton (CA); Sean Maloney, Bolton (CA); Justin Morton, Bolton (CA)

(21) Appl. No.: 15/301,822

(22) PCT Filed: Apr. 2, 2015
(86) PCT No.: PCT/CA2015/000227

§ 371 Date: Oct. 4, 2016

Related U.S. Application Data
(60) Provisional application No. 61/975,273, filed on Apr. 4, 2014.

(51) Int. Cl. F16K 27/02; F16K 15/14

(52) U.S. Cl. CPC F16K 27/0236; F16K 15/144

(57) ABSTRACT

A valve closure for a dispenser comprises a rigid body portion and a flexible diaphragm that engages the body portion when the valve closure is mounted in the dispenser. The valve closure may include a combination central boss/pin and dispensing orifice that, through a self-closing and self-sealing action, cuts off material flow following dispensation. Such configuration of a central boss/pin may also tend to prevent or at least reduce orifice re-healing by holding open the orifice during periods of non-use when the orifice is cut-off to material flow. For example, the central boss/pin may include an undercut region with which an annular lip of the orifice may engage to seal the orifice. The valve closure may further include a secondary channel, in addition but separate to a primary fluid flow channel, which may be used to provide external air venting that is completely or substantially de-coupled from fluid dispensation.

### CROSS-REFERENCE TO RELATED APPLICATIONS

This application claims all right, benefit, and priority of U.S. Provisional Application Ser. No. 61/975,273, filed Apr. 4, 2014, the entire contents of which are herein incorporated by reference.

### TECHNICAL FIELD

The disclosure relates generally to a valve closure for a liquid dispenser and, more specifically, to a valve closure with a self-closing, self-venting diaphragm.

### BACKGROUND

Certain dispensers of flowable material, such as resilient containers, tubes and/or bottles, are provided with a closure valve. When the dispenser is actuated, a flow of housed material is transported through the valve and out of the dispenser. Following actuation of the dispenser, the dispenser and/or closure valve may return to a pre-dispensing state or position in which no significant flow of the dispensed material remains. In many configurations, actuation may involve physical deformation of the dispenser, such as through a pressing or squeezing action, thereby creating a pressure differential within the dispenser that forces open the closure valve to material flow. For example, these configurations of dispensers may commonly be employed for liquid or semi-liquid food products, such as condiments, jams, honeys, syrups, and others, as well as household products, like soaps, cleaners, detergents, etc. without limitation.

### BRIEF DESCRIPTION OF THE DRAWINGS

To describe various different embodiments of an invention or multiple inventions, including at least one preferred embodiment thereof, reference will be made herein throughout to the accompanying drawings, in which:

FIG. 1A shows a perspective view of a valve system;

FIGS. 1B-1D show side, top and bottom views, respectively, of the valve system shown in FIG. 1A;

FIG. 2A shows a cross-sectional view, taken along line A-A, of the valve system shown in FIGS. 1A-1D when in a resting state;

FIG. 2B shows a cross-sectional view, taken along line A-A, of the valve system shown in FIGS. 1A-1D when in a dispensing state; and

FIG. 2C shows a cross-sectional view, taken along line A-A, of the valve system shown in FIGS. 1A-1D when in a venting state.

For clarity and ease of description, like reference numerals will be used in the drawings to describe the same or like parts.

### DETAILED DESCRIPTION

Many valve closures are intended for installation into dispensers, such as for food products or household items, which are intended or designed for limited-use involving only a single use and, perhaps, also a small number of re-uses before the dispenser is disposed of or recycled along with the valve closure. Thus, economic considerations may place some constraints on the cost and/or complexity of valve closure design for such limited-use dispensers. Likewise the relatively small size of many limited-use dispensers may also impose design constraints. Consequently, many configurations of valve closures for dispensing liquids and/or semi-liquids may experience a number of shortcomings or disadvantages, such as inconsistent flow rates, incomplete flow cut-off, imperfect air seal, and others.

One particular issue that some configurations of a valve closure may experience relates to orifice re-healing. What can happen is that over an extended period of non-use, polymer(s) used in the valve may begin to cross-link and form new bonds. Thus, the lips or edges of the primary dispensing orifice in the valve, if left in contact with each other over a sufficiently long period, may begin forming or re-forming bonds that will need to be broken the next time the dispensing orifice is used. The extra force required to crack open the partially closed orifice may require additional load to be applied to the dispenser. This increased load requirement will then in turn increase fluid pressure prior to orifice opening, resulting in excessive or larger than expected material flow rate when the orifice is eventually opened. Orifice re-healing may therefore produce inconsistent flow rates out of a dispenser and generally reduce flow rate control.

Another potential issue in some configurations of valve closures relates to venting and flow cut-off. Specifically, positive pressure differential that is developed in a valve closure so as to crack open the dispensing orifice generally has to be diffused following dispensing. One way to do this involves venting the valve closure with external air until pressure in the valve closure is normalized. However, if the primary orifice that is used in the valve closure for dispensing is also subsequently used for venting, there is a possibility of unintended material leakage through the still open orifice. In addition to reducing general cleanliness, seeping material into the dispenser cap area may also tend to create blockages in the dispenser orifice that can interfere with material flow if not cleared, which again may tend to reduce rate control and produce inconsistent flow rates after periods of non-use. Thus, it may also be desirable, advantageous and/or otherwise convenient for a valve closure to provide complete cut-off of material flow with no or only minimal material leakage following dispensing.

Accordingly, embodiments of the invention(s) described herein provide a valve closure comprising a rigid body portion and a flexible diaphragm that cooperates with the body portion so as to address or ameliorate at least one of the shortcomings of existing valve configurations as described herein. For example, embodiments of the disclosed valve closure may include a combination central boss/pin and dispensing orifice that, through a self-closing and self-sealing action, cuts off material flow following dispensation. Such configuration of a central boss/pin may also prevent or tend to prevent or at least reduce orifice re-healing by holding open the orifice during periods of non-use when the orifice is cut-off to material flow. Embodiments of the disclosed valve closure may also include or further include a secondary channel, in addition to a primary fluid flow channel, which together with other element(s) may be used to provide external air venting that is completely or substantially de-coupled from fluid dispensation. Further embodiments may also confer one or more additional benefit(s) and/or advantage(s).

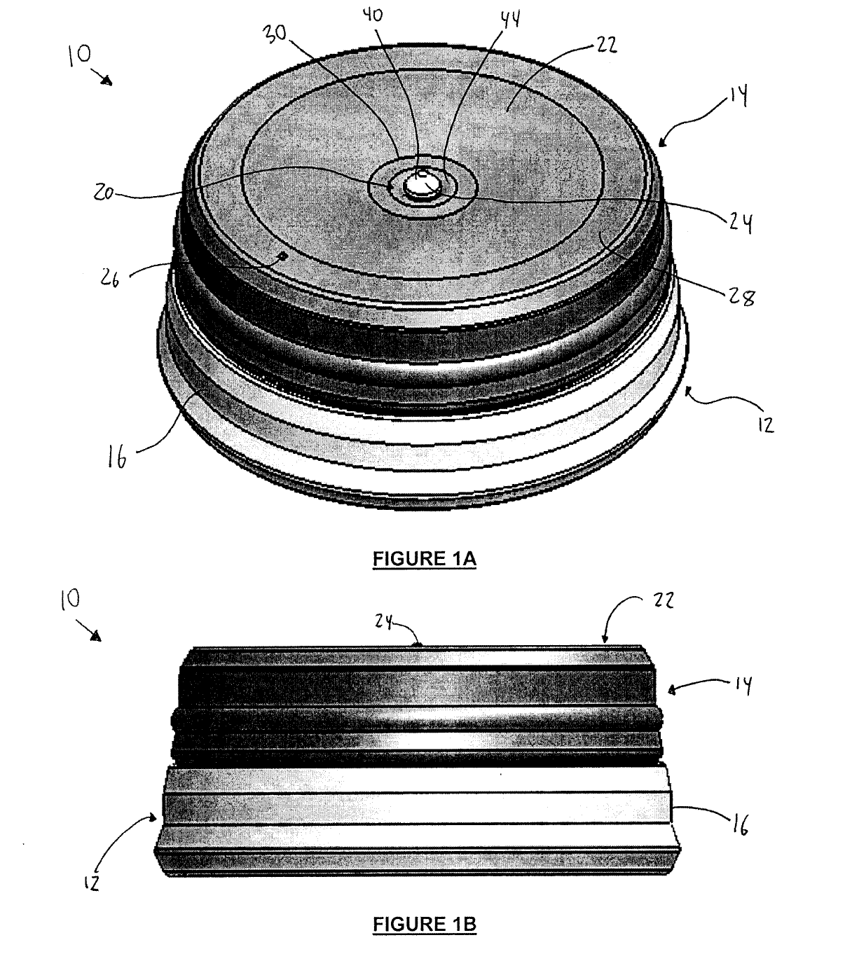

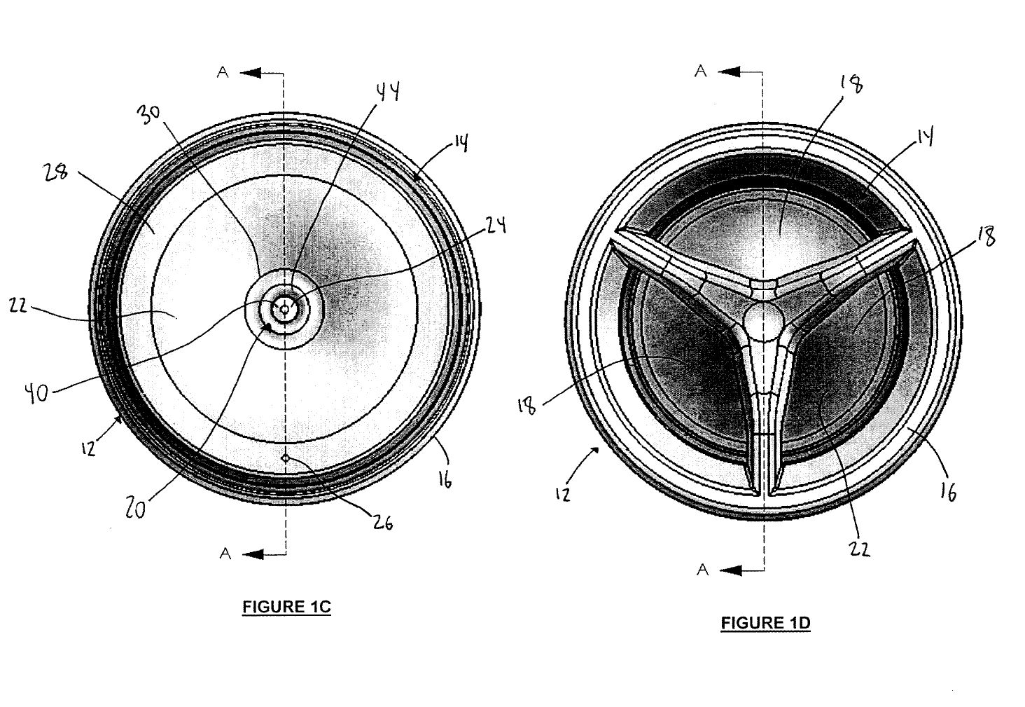

For a thorough understanding of the described embodiments, reference is initially made to FIGS. 1A-1D, which show an example valve, generally denoted 10, in various different views according to the disclosure. Valve 10 may be any assembly and/or system comprising one or more integrated or cooperative components that together function so as to achieve one or more different results as herein described. For example, different embodiments of valve systems and/or assemblies according to the disclosure may be useful to dispense flowing materials, such as liquid(s), semi-liquid(s), paste(s), gel(s), putty(ies), and jelly(ies) with controlled flow rates, resistance to valve re-sealing during periods of non-use, and/or decoupled venting and dispensing mechanisms. For convenience, terms such as “fluid” or “liquid” may be used interchangeably to encompass and refer to any flowable material as described herein.

Accordingly, in one example embodiment, a valve 10 may include a rigid body portion 12 and a flexible diaphragm 14 that is adapted to cooperate with body portion 12 so as to provide a one-way valve closure that can be mounted into the neck of a dispenser or other container of flowable materials, such as bottles, tubes, and the like. As described herein, valve 10 may conduct flowable material substantially only in one direction when actuated, while constituting an effective barrier to material flow(s), including air and other gases, in the opposite direction. Thus, when mounted into a dispenser or other container, valve 10 may provide an effective mechanism for conducting a flow of material out of the dispenser, e.g., by way of controlled actuation involving physical deformation of or pressure applied to the dispenser.

As shown, diaphragm 14 may be constituted as a separate body or, alternatively, may be integrally formed with or otherwise affixed to body portion 12. For example, in some cases, body portion 12 and diaphragm 14 may be fused or chemically bonded together so as to constitute a single body. In other cases, including as in the example configuration shown, body portion 12 and diaphragm 14 may be separate bodies within a valve system or assembly that are shaped for mutual cooperation.

Body portion 12 may include a peripheral wall 16 with a generally hollow cylindrical aspect to which the shape of diaphragm 14 may couple or otherwise engage. Thus, in some cases, diaphragm 14 may be mounted onto body portion 12 so as to sit or rest (generally be carried) on top of peripheral wall 16 (although it will be appreciated that terms such as “top” or “bottom” are not intended herein to denote absolute directions or orientations, but rather are intended for convenience to denote relative directions in relation to an appropriate reference point). When mounted securely within a dispenser or container neck, in use, body portion 12 and diaphragm 14 may be held together by press-fit engagement and other contact forces, thereby forming a good seal therebetween (other than through designated orifices and fluid flow channels as described herein).

Body portion 12 may be formed out of a suitably rigid material, for example, but not limited to, hard plastics, resins, etc., which provide body portion 12 with substantial dimensional stability. Thus, body portion 12 may generally hold its shape without undergoing significant flex or deformation when subjected to a range of low level forces and/or pressures. On the other hand, diaphragm 14 is flexible and may be formed out of different soft materials suitable for its purpose(s), such as soft or semi-soft polymers, elastomers, etc. As explained more below, suitable materials for diaphragm 14 will be those which allow diaphragm 14 to deform or deflect under pressure differential within a range that could be created through physical deformation, e.g., squeezing, of a material dispenser into which valve 10 has been installed. As used herein, terms such as “deflection” or “deformation” may be used to denote any temporary change in dimension or physical aspect, which may include elastic changes, occurring in response to an applied force.

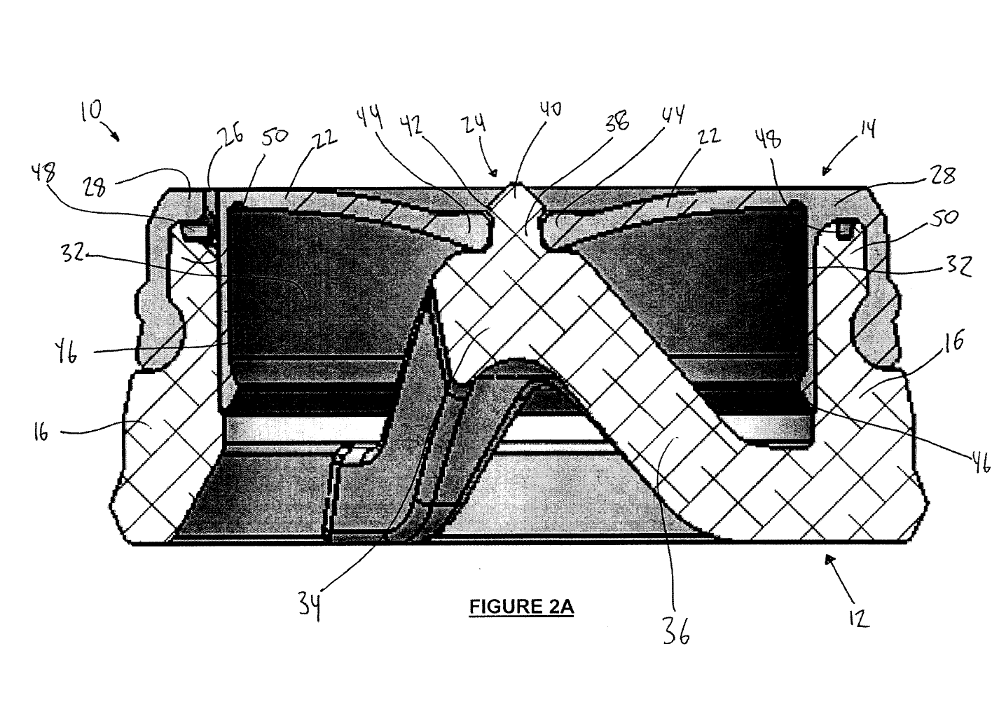

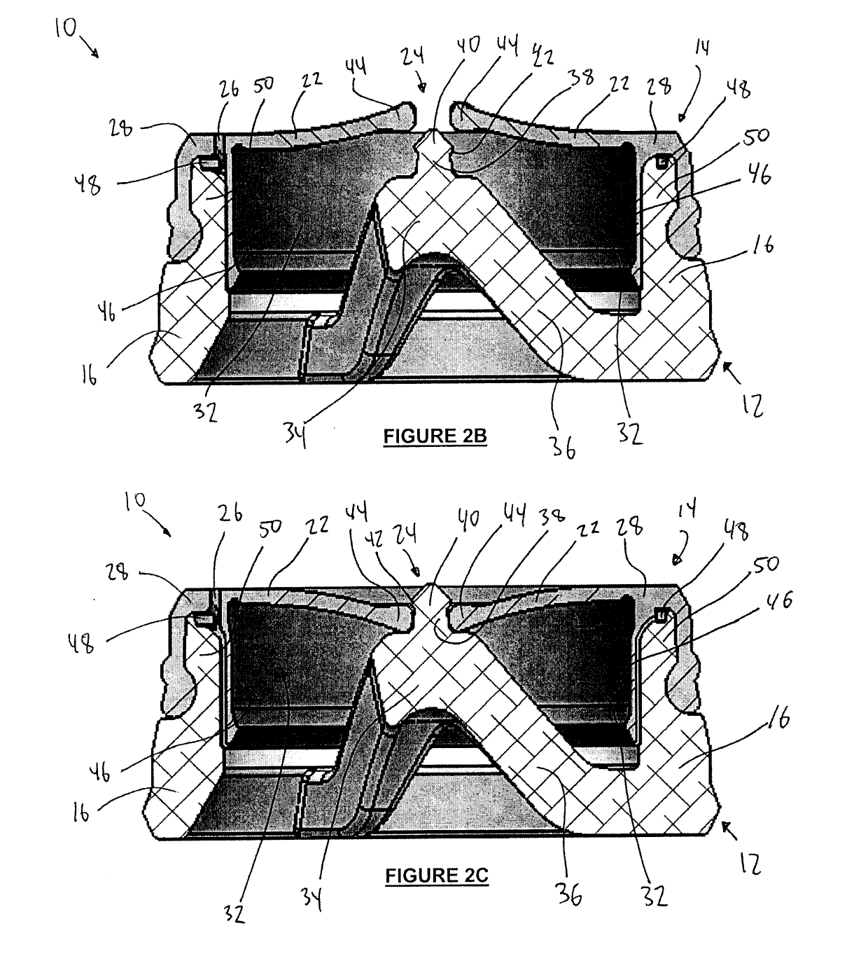

As seen in FIG. 1D, peripheral wall 16 defines one or more fluid channels 18 communicated between the interior of a dispenser (not shown), into which valve 10 is mounted, and diaphragm 14 which is engaged to body portion 12. A central orifice 20 defined in an end wall 22 of diaphragm 14 is in communication with fluid channel(s) 18. When valve 10 is in a rest or static state (shown in and explained further with reference to FIG. 2A), a central boss/pin 24 of body portion 12 extends through orifice 20 thereby effectively blocking fluid flow therethrough and maintaining the cross-sectional profile of orifice 20. However, when in a dispensing state (shown in and explained further with reference to FIG. 2B), orifice 20 is deflected outward from boss/pin 24 and free to conduct flowable material housed in the dispenser, thereby providing a point of egress from the dispenser or container.

In some embodiments, a secondary air vent 26 is also defined in a peripheral region 28 of end wall 22, spaced apart radially from central orifice 20, which may generally be defined in a central region 30 of end wall 22. Secondary air vent 26 may provide an additional fluid channel that can fluidly couple the interior and exterior of valve 10, but which is separate from the fluid channel defined through central orifice 20. Air vent 26 may therefore provide a path, when valve 20 is in a venting state (shown in and explained further with reference to FIG. 2C), distinct from orifice 20 used during dispensation, for normalizing pressure within valve 10 and/or the dispenser in which valve 10 may be affixed.

Referring now to FIG. 2A, there is shown a cross-sectional view of valve system 10, taken along line A-A, when in a static or resting state. In such state, as mentioned above, diaphragm 14 may assume a shape or positioning in which central boss/pin 24 of body section 12 is at least partially extended through orifice 10 defined in diaphragm 14, thereby closing off an interior space 32 within valve 10 to fluid communication with the space exterior to valve 10. As described more below, such a static or resting state may, constitute a default state to which valve system 10 is biased and to which valve system 10 may therefore tend to return, when not actively in a dispensing state (FIG. 2B) or a venting state (FIG. 2C) following occurrence of a dispensing state.

As shown, in some embodiments, central boss/pin 24 may project upwardly from a hub 34 of body portion 12 that is supported centrally within interior space 32 using one or more spokes 36 extending between hub 34 and peripheral wall 16. A number of different spokes 36, for example, three or more, may be defined in body portion 12, each such spoke 36 having an equal or approximately equal angular spacing around peripheral wall 16. Thus, for configurations involving three separate spokes 36, an angular spacing of approximately 120 degrees between each may be provided; likewise for a configuration with four spokes, the angular spacing may be approximately 90 degrees between adjacent spokes. The depicted configuration of body portion 12 incorporates three different spokes 36 (see, e.g., FIG. 1D), but different numbers and/or angular spacing of spokes to what is/are explicitly shown and described may be possible as well.

In some embodiments, central boss/pin 24 may have a composite shape including at least an undercut region 38 projecting immediately out from a terminal portion of hub 34, and a head 40 that is transistioned integrally out from undercut region 38, but separated therefrom by an annular lip 42. Thus, undercut region 38 may have a generally cylindrical or neck-shaped profile with dimensionality(ies), as discussed more below, which allow undercut region 38 to be accommodated by central orifice 20, such that diaphragm 14 is able to fluctuate on and off central boss/pin 24 during operation in response to created pressure differential within valve 10. The dimensionality of undercut region 38, also as discussed more below, may also contribute to flow rate control of material through central orifice 20.

In some embodiments, head 40 may be provided with a taper, starting at lip 42 and tending in a direction away from undercut region 38, so as to have a shape that is generally pyramidal (e.g., a circular pyramid) or, alternatively, frustoconical (as shown). As mentioned above, during a dispensation phase of valve 10, diaphragm 14 may be lifted off from body portion 12, especially central boss/pin 24, by fluid pressure build-up within valve 10 and suspended temporarily in air, spaced-apart therefrom, before re-engagement with boss/pin 24 following completion of the dispensation phase and pressure normalization. The tapered shape of head 40 may assist with guiding diaphragm 14 back onto body portion 12 by facilitating threading of head 40 through orifice 20, e.g., due the relatively small profile of head 40 at its terminal extreme as compared to the cross-sectional area of orifice 20.

As described herein, diaphragm 14 may further include a reinforcement region 44 in the shape of an annular lip that surrounds orifice 20 within central region 30. As compared to other regions of end wall 22, reinforcement region 44 may have an increased wall thickness that increases dimensional stability of orifice 20, especially cross-sectional area, when diaphragm 14 is subjected to force or pressure differential during a dispensation state. Thus, in some embodiments, end wall 22 may undergo a gradual thickening, within the central region 30 in an inwardly radial direction toward orifice 20, so as to define reinforcement region 44. As explained further below, the dimensional stability provided to orifice 20 by reinforcement region 44 may also contribute to flow rate control during material dispensation therethrough.

As shown in FIG. 1A, diaphragm 14 may further include a peripheral wall 46 depending inwardly from end wall 22 into the interior space 32 defined within body portion 12. Thus, peripheral wall 46 may depend inwardly from end wall 22 spaced radially outward apart from orifice 20 by slightly less than the radial spacing of peripheral wall 16 of body portion 12, such that the two peripheral walls, 16 and 46, are in relatively close proximity to one another. Peripheral wall 46 may be relatively thin and, like the rest of diaphragm 14, composed of a flexible material, such as soft or semi-soft polymers or elastomers, so as to be deformable through applied forces and/or pressure differentials. In some cases, as described more below, the proximity of peripheral walls 16 and 46 may be such that deformation of peripheral wall 46, resulting from being subjected to force and/or pressure differential, will be sufficient so as to bring peripheral wall 46 either into (e.g., FIGS. 2A and 2B) or out of (e.g., FIG. 2C) contact with peripheral wall 16, thereby allowing for venting of valve 10 with external air.

In some embodiments, peripheral wall 16 of body portion 12 also defines an annular recess or groove 48 running circumferentially within a terminal region 50 of peripheral wall 16, situated proximately to the interface between peripheral wall 16 and peripheral region 28 of diaphragm 14. Annular recess 48 may thereby define an interior space between peripheral wall 16 and end wall 22 of diaphragm 14, which is in constant fluid communication through secondary air vent 26 with the exterior space outside of valve 10. Fluid communication between annular recess 48 and interior space 32 may also be intermittently provided, as described below, depending on whether or not peripheral walls 16 and 46 are engaged and in fluid sealing contact with one another.

Referring now to FIG. 2B, there is shown the configuration of a valve system 10, in cross-section view taken along line A-A, when in the dispensing state. As can be seen, when in a dispensing state, diaphragm 14 is disengaged from body portion 12 and flexed outwardly creating separation between orifice 20 and central boss/pin 24. Once disengaged, a fluid flow channel is opened through orifice 20 into the interior space 32 defined within body portion 12 and thereon into a dispenser or container to which valve 10 has been secured. Thus, a fluid flow channel for dispensation of any housed material is created.

In operation, a positive pressure differential (relative to the environment outside of valve 10) may be created within valve 10, for example, through mechanical forces like squeezing or pressing applied to the dispenser, which has the effect of forcing flowable material into interior space 32 of valve 10. Building fluid pressure within valve 10 may cause diaphragm 14 to begin pressing against lip 42 of boss/pin 24, which will initially tend to resist such pressure buildup and hold diaphragm 14 static. However, when the building fluid pressure differential exceeds a minimum threshold, diaphragm 14 will overcome the resistance provided by lip 42 and will be dislodged or disengaged from its resting or static position on body portion 12 (in which boss/pin 24 is received into orifice 20). Sustained fluid pressure within valve 10 will then move and hold diaphragm 14 into the position shown in FIG. 2B causing a fluid channel through orifice 20 to be opened.

The positive pressure differential created within valve 10 that forces open a fluid channel through orifice 20, during the dispensing state, may also tend to exert forces in a radially outward direction within interior space 32. Such force(s) act on peripheral wall 46 causing radially outward deformation that brings peripheral walls 16 and 46 together (peripheral wall 16 may generally be static, but peripheral wall 46 flexible) and creates a liquid seal therebetween, which closes off any channel for fluid to flow through annular recess 48 and secondary air vent 26. Thus, during material dispensing, the only fluid channel opened to the exterior of valve 10 may be through central orifice 20.

According to the embodiments described herein, flow rate control through the central orifice 20 during material dispensation may be influenced and effectively controlled by interaction between orifice 20 and central boss/pin 24. For example, the size of undercut region 38 and/or of lip 42 (around which orifice 20 is received in the resting state) may influence the minimum threshold pressure differential above which diaphragm 14 will be flexed outwardly to open up the fluid channel through orifice 20. By controlling the minimum threshold pressure, the flow rate can be controlled by the subsequent deformation in orifice 20 due to the minimum threshold pressure.

In addition, because diaphragm 14 after completion of a dispensing phase comes to rest again on body portion 12 (e.g., FIG. 2A), the state to which diaphragm 14 may be biased, with orifice 20 in particular being penetrated by phase boss/pin 24, the dimensionality of orifice 20 is relatively unchanged during rest phases between successive states of dispensing (although the fluid channel through orifice 20 may be effectively closed). Thus, the lips or edges of orifice 20 are kept apart from and out of contact with other, which in turn tends to prevent re-healing or re-bonding when not in use. In contrast, as mentioned above, other configurations of valves and/or orifices, especially those with orifices comprising linear geometries, such as slits or crosses, may tend to be susceptible to orifice re-healing, if orifice dimensionality is not preserved and the edges or lips of the orifice are allowed to make contact during periods of non-use.

When re-healing or re-bonding occurs, the pressure differential that will be sufficient to break any re-healed bonds that may have formed (and thereby crack the orifice back open) may tend to be greater than a pressure differential that would have been sufficient to open the same orifice had no re-healing occurred. This unpredictable crack pressure differential may cause inconsistent flow rate of material insofar as the greater crack pressure to overcome a re-healed orifice may consequently generate an increased or elevated material flow rate to what is intended (and to what would be expected when lower pressure differentials are utilized for orifices that have not experienced significant re-healing). In any event, as the interaction between central orifice 20 and boss/pin 24 may prevent or substantially prevent orifice re-healing, embodiments of valve 10 according to the disclosure may thereby eliminate or at least mitigate re-healing and its consequent undesirable effect(s) on flow rate control.

Referring now to FIG. 2C, there is shown the configuration of a valve system 10, in cross-sectional view taken along line A-A, when in a venting state. As seen, in comparison to the dispensing state shown in FIG. 2B, when valve 10 is in the venting state, diaphragm 14 has returned to its resting or bias position on and in contact with body portion 12, while peripheral wall 46 has moved radially inwardly, i.e., away from peripheral wall 16, to thereby open up a fluid channel between the interior space 32 of body portion 12 and recess 48 (and onward to the exterior of valve 10 by way of secondary air vent 26). Thus, in the venting state, when the fluid channel through orifice 20 has been closed to the exterior of valve 10, a secondary fluid channel through air vent 26 has been opened.

In operation, following material dispensation, a negative pressure differential (again relative to the environment outside of valve 10) may be developed within valve 10, for example, as the resilient dispenser returns to its original, pre-dispensing state and draws air and/or fluid out of interior space 32 and back into the body of the dispenser. Such negative pressure differential may thereby create a vacuum or partial vacuum within valve 10 that draws diaphragm 14, previously outwardly flexed, back inward and into engagement with central boss/pin 24 of body portion 12 and effectively closes the fluid channel through orifice 20. However, the negative pressure differential created in the interior space 32 may additionally draw peripheral wall 46 radially inward, as described, so as to open up a fluid channel to the outside through annular recess 48 and secondary air vent 26. As outside air is drawn into valve 10 through secondary air vent 26, pressure within interior space 32 is able to normalize, e.g., move closer in value toward the outside environment pressure. In response to this pressure normalization, peripheral wall 46 may gradually migrate, in a radially outward direction, until contact with peripheral wall 16 is re-established and the fluid channel to the exterior of valve 10 through secondary air vent 26 is effectively re-sealed.

With use of secondary air vent 26 instead, pressure normalization within valve 10 may occur in a manner that is completely or substantially completely independent of orifice 20, which is closed off by the return of diaphragm 14 to rest on body portion 12 following material dispensation. This can be advantageous, as described herein, for example, because use of the same orifice for material dispensation and air venting may tend to increase the instance of undesirable material seepage when not actively dispensing. However, use of a secondary air vent 26 for venting may otherwise allow a primary dispensation orifice, i.e., orifice 20 to be closed to further fluid flow therethrough immediately or almost immediately. The amount of material that can inadvertently seep or leak out of such primary dispensation orifice when not actively dispensing is thereby reduced.

Decoupling of material dispensation through orifice 20 and air venting through secondary air vent 26 may further be increased by the relative geometries of body portion 12 and diaphragm 14. For example, the outward radial spacing of peripheral wall 46 relative to orifice 10 may tend to cause the peripheral region 26 of diaphragm 14 to behave as a stationary or quasi-stationary region. Thus, as can be seen in FIG. 2B, outward flexing of the central region 30 of diaphragm 14 during dispensation, so as to open up a fluid channel through orifice 20, does not cause appreciable axial displacement of peripheral region 28, which remains engaged to and in contact with peripheral wall 16 of body portion 12. Consequently, while peripheral wall 46 may flex radially inwardly (FIG. 2C) and outwardly (FIGS. 2A and 2B) in response to pressure differential(s), there is little axial movement of peripheral wall 46 along peripheral wall 16 (due to the stationary or quasi-stationary behavior of peripheral region 26). This action of peripheral wall 46 contributes to decoupling of the dispensing and venting actions of valve 10.

The above description is intended to provide a thorough description of various aspects and example embodiments of one or more inventions. Accordingly, various aspects and/or components of such invention(s) have been described throughout at multiple different levels of abstraction. In some instances, embodiments may have been described on both a specific and a relatively general or generic level, for example, where an aspect or component of the embodiment is susceptible to variation in a manner that is not inconsistent with the specific structure(s) and/or operation(s) set forth. In these instances, the specific embodiments set forth herein may not be the only ones contemplated and instead may only be exemplary of a more general or generic configuration. The scope of the invention(s) described herein is therefore defined solely by the language of the claims appended hereto, giving due consideration to applicable doctrines for construing their meaning.

1. A valve closure for a dispenser, comprising:
a rigid body portion that is mountable within an opening in the dispenser, the body portion comprising an outer peripheral wall that defines one or more fluid channels through the body portion in communication with the opening in the dispenser when mounted therein, and a boss/pin having an undercut portion depending from an annular lip; and
a flexible diaphragm that is carried on the outer peripheral wall when the body portion is mounted in the opening of the dispenser, the diaphragm comprising an end wall that is deformable at least axially in response to pressure changes within the one or more fluid channels, the end wall defining an orifice in substantial alignment with the boss/pin;
wherein the end wall of the diaphragm is biased to rest on the outer peripheral wall with the boss/pin received through the orifice as far as the undercut portion and the annular lip engaged so as to effectively close the orifice to fluid flow therethrough.

2. The valve closure of claim 1, wherein the end wall is disengageable from the annular lip through axially outward deflection of the end wall, disengagement of the end wall opening a fluid pathway through the orifice.

3. The valve closure of claim 1, wherein the body portion further comprises a hub supported interiorly of the outer peripheral wall.

4. The valve closure of claim 3, wherein the hub is supported on one or more spokes extending from the outer peripheral wall, the one or more fluid channels through the body portion being defined by the one or more spokes.

5. The valve closure of claim 3, wherein the boss/pin projects outwardly from a terminal portion of the hub.

6. The valve closure of claim 1, wherein the boss/pin further comprises a head that is transitioned integrally out from the undercut region separated therefrom by the annular lip.

7. The valve closure of claim 6, wherein the head is tapered moving away from the undercut region.

8. The valve closure of claim 1, wherein the end wall comprises a reinforcement region in a vicinity of the orifice, the reinforcement region having a greater wall thickness than at least one other portion of the end wall.

9. The valve closure of claim 8, wherein the reinforcement region comprises an annular lip surrounding the orifice that is shaped for engagement with the annular lip of the boss/pin.

10. The valve closure of claim 1, wherein the diaphragm further comprises an inner peripheral wall depending from the end wall radially inward of and proximate to the outer peripheral wall of the body portion, the inner peripheral wall deformable at least radially in response to pressure changes within the at least one fluid channel.

11. The valve closure of claim 1, wherein the outer peripheral wall defines an annular recess therein, the annular recess being fluidly coupled to the at least one fluid channel when the inner peripheral wall, through radially inward deformation, is disengaged from the outer peripheral wall opening an alternative fluid pathway to the at least one fluid channel when the orifice is effectively closed to fluid flow through engagement of the boss/pin with the end wall.

12. The valve closure of claim 11, wherein the annular recess is defined in a terminal region of the outer peripheral wall.

13. The valve closure of claim 11, wherein the end wall further defines a secondary air vent in a peripheral region thereof, the secondary air vent being in constant fluid communication with the annular recess.

14. The valve closure of claim 13, wherein the peripheral region of the end wall remains substantially stationary and engaged with the outer peripheral wall of the body portion when the end wall is deflected axially outward.

15. The valve closure of claim 11, wherein the inner peripheral wall, through radially outward deformation, is engageable with the outer peripheral wall forming a fluid seal therewith between the annular recess defined in the outer peripheral wall and the one or more fluid channels through the body portion.

16. A valve closure for a dispenser, comprising:
a rigid body portion that is mountable within an opening in the dispenser, the body portion comprising an outer peripheral wall and a boss/pin supported interiorly thereof, the outer peripheral wall defining at least one fluid channel through the body portion in communication with the opening in the dispenser when mounted therein, and further having an annular recess defined therein; and
a flexible diaphragm that is carried on the outer peripheral wall when the body portion is mounted in the opening of the dispenser, the diaphragm comprising an end wall that defines an orifice in substantial alignment with the boss/pin, and an inner peripheral wall depending from the end wall radially inward of and proximate to the outer peripheral wall of the body portion, the inner peripheral wall deformable at least radially in response to pressure changes within the at least one fluid channel;
wherein the annular recess is fluidly coupled to the one or more fluid channels when the inner peripheral wall, through radially inward deformation, is disengaged from the outer peripheral wall opening an alternative fluid pathway to the one or more fluid channels when the orifice is effectively closed to fluid flow through engagement of the boss/pin with the end wall.

17. The valve closure of claim 16, wherein the annular recess is defined in a terminal region of the outer peripheral wall.

18. The valve closure of claim 16, wherein the end wall further defines a secondary air vent in a peripheral region thereof, the secondary air vent being in constant fluid communication with the annular recess.

19. The valve closure of claim 18, wherein the peripheral region of the end wall remains substantially stationary and engaged with the outer peripheral wall of the body portion when the end wall is deflected axially outward.

20. The valve closure of claim 16, wherein the inner peripheral wall, through radially outward deformation, is engageable with the outer peripheral wall forming a fluid seal therewith between the annular recess defined in the outer peripheral wall and the one or more fluid channels through the body portion.
